(19) United States
(12) Patent Application Publication
(10) Pub. No.: US 2006/0237096 A1
(43) Pub. Date: Oct. 26, 2006

(54) Soft magnetic material, dust core, transformer core, motor core, and method for producing dust core

(76) Inventors: Haruhisa Toyoda, Hyogo (JP); Ryuji Shiga, Hyogo (JP); Hirokazu Kugai, Hyogo (JP); Yoshiyuki Shimada, Hyogo (JP); Shohzoh Tanaka, Nara (JP); Kazuhiko Ueda, Nara (JP)

Correspondence Address: MCDERMOTT WILL & EMERY LLP, 600 13TH STREET, N.W., WASHINGTON, DC, 20005-3096, US

(21) Appl. No.: 10/565,939

(22) PCT Filed: Jul. 30, 2004
(86) PCT No.: PCT/JP04/10954

§ 371 Date: Jan. 26, 2006

(30) Foreign Application Priority Data
Jul. 30, 2003 (JP) 2003-282961

(51) Int. Cl. H01F 1/26

(52) U.S. Cl. 148/104

(57) ABSTRACT

A soft magnetic material includes a plurality of composite magnetic particles each having a metal magnetic particle and an insulating film surrounding a surface of the metal magnetic particle, and an organic substance joining the plurality of composite magnetic particles together. The organic substance has a deflection temperature under load of not more than 100° C. With this structure, the soft magnetic material can obtain a desired magnetic property.

### TECHNICAL FIELD

The present invention generally relates to a soft magnetic material, a dust core, a transformer core, a motor core, and a method of manufacturing a dust core. More particularly, the present invention relates to a soft magnetic material having a composite magnetic particle formed of a metal magnetic particle and an insulating film covering the metal magnetic particle, a dust core, a transformer core, a motor core, and a method of manufacturing a dust core.

### BACKGROUND ART

Recently, attempts have been made to provide electric and electronic components such as a motor core and a transformer core having higher densities and smaller sizes to meet the demand for more precise control with low electric power. This has lead to the development of soft magnetic materials for use in the fabrication of such electric and electronic components, in particular, those having excellent magnetic property in the middle to high frequency range.

Regarding such a soft magnetic material, for example Japanese Patent Laying-Open No. 2002-246219 discloses a dust core designed to be-capable of maintaining a magnetic property even when it is used under a high-temperature environment, and a method of manufacturing the same (Patent Document 1). According to the method of manufacturing a dust core disclosed in Patent Document 1, atomized iron powder covered with phosphate film is firstly mixed with a predetermined amount of polyphenylene sulfide (a PPS resin), and then undergoes compression molding. The resulting molding is heated at a predetermined temperature, and then cooled to fabricate a dust core.

Patent Document 1: Japanese Patent Laying-Open No. 2002-246219

### DISCLOSURE OF THE INVENTION

Problems to be Solved by the Invention

The effective magnetic permeability of the dust core fabricated by the above manufacturing method is substantially linearly reduced with an increase in the content of the PPS resin at a frequency of 50 Hz. Further, at a frequency of 5000 Hz, the effective magnetic permeability of the dust core is low when the dust core has no PPS resin, and reaches its maximum when the content of the PPS resin is around 0.3% by mass. If the dust core contains the PPS resin more than that amount, the effective magnetic permeability is reduced as in the case of the frequency of 50 Hz.

Accordingly, when the content of the PPS resin is increased, the ratio of iron base to the total amount decreases, causing a reduction in the effective magnetic permeability of the dust core. Further, if the content of the PPS resin is too low, an interparticle eddy current loss in atomized iron powder covered with phosphate film is increased when a high frequency is applied, causing a reduction in the effective magnetic permeability of the dust core. To solve such problems, it is necessary to allow the phosphate film covering the atomized iron powder to sufficiently serve as an insulating layer to reliably suppress an occurrence of interparticle eddy current regardless of the content of the PPS resin.

Therefore, one object of the present invention is to solve the above problems, and to provide a soft magnetic material having a desired magnetic property, a dust core, a transformer core, a motor core, and a method of manufacturing a dust core.

Means for Solving the Problems

A soft magnetic material according to the present invention includes a plurality of composite magnetic particles each having a metal magnetic particle and an insulating film surrounding a surface of the metal magnetic particle, and an organic substance joining the plurality of composite magnetic particles together. The organic substance has a deflection temperature under load of not more than 100° C. (under a load of 1.82 MPa).

A deflection temperature under load (a thermal deformation temperature) is a temperature measured by a method of testing a deflection temperature under load prescribed in JIS K 7207₋₁₉₈₃. In the test method, both ends of a test piece are supported in a heating bath, and the temperature of a transfer medium is raised at a rate of 2° C. per minute while a predetermined bending stress is applied to the test piece with a loading bar in the center. The temperature of the transfer medium when bending of the test piece reaches a predetermined value is determined as the deflection temperature under load of a material forming the test piece.

With the soft magnetic material formed in this manner, when a mixture of the plurality of composite magnetic particles and the organic substance is subjected to compression molding, heat generated by the compression raises the temperature of the mixture to a temperature close to 100° C. On this occasion, the organic substance serves as a cushioning material between the plurality of composite magnetic materials since the organic substance has the deflection temperature under load of not more than 100° C. (under the load of 1.82 MPa). This function of the organic substance can prevent the composite magnetic particles from rubbing against each other to apply a local force to the insulating film surrounding the surface of the metal magnetic particle during the compression molding. Thereby, insulation between the metal magnetic particles by means of the insulating film can be maintained even after the compression molding, suppressing an occurrence of interparticle eddy current. Therefore, according to the present invention, a soft magnetic material in which a reduction in magnetic permeability is suppressed even when a high-frequency alternating-current magnetic field is applied can be implemented.

Preferably, a ratio of the organic substance to the soft magnetic material is more than 0 and not more than 1.0% by mass. With the soft magnetic material formed in this manner, the organic substance serves as a cushioning material, and at the same time, there is no possibility that a ratio of the metal magnetic particle to the soft magnetic material will become too low. This can suppress an occurrence of interparticle eddy current and achieve a magnetic flux density of not less than a predetermined value.

More preferably, the ratio of the organic substance to the soft magnetic material is more than 0 and not more than 0.5% by mass. Further preferably, the ratio of the organic substance to the soft magnetic material is more than 0 and not more than 0.3% by mass. With the soft magnetic material formed in this manner, a magnetic flux density having a higher value can be obtained by increasing the ratio of the metal magnetic particle in the soft magnetic material.

A dust core according to the present invention is a dust core using the soft magnetic material described above. Preferably, in a dust core using the soft magnetic material containing the organic substance by more than 0 and not more than 1.0% by mass, a magnetic flux density when a magnetic field of 100 (oersted) is applied is not less than 1.3 (T: tesla). Also preferably, in a dust core using the soft magnetic material containing the organic substance by more than 0 and not more than 0.5% by mass, a magnetic flux density when a magnetic field of 100 (oersted) is applied is not less than 1.4 (T: tesla).

A transformer core according to the present invention uses the dust core having the magnetic flux density when a magnetic field of 100 (oersted) is applied of not less than 1.4 (T: tesla). The ratio of the organic substance to the soft magnetic material is not less than 0.3% by mass and not more.than 0.5% by mass.

The dust core according to the present invention preferably uses the soft magnetic material containing the organic substance by not less than 0.3% by mass and not more than 0.5% by mass. The dust core is formed as a hollow cylinder having a height H and a wall thickness T. Height H is not less than 25 mm, and a ratio H/T of height H to wall thickness T is not less than 3.

With the dust core formed in this manner, by setting the ratio of the organic substance at not less than 0.3% by mass and not more than 0.5% by mass, the occurrence of interparticle eddy current can further be suppressed and the magnetic flux density can further be improved. At the same time, by setting the ratio of the organic substance at not less than 0.3%, the organic substance sufficiently serves as a lubricant during the compression molding of the soft magnetic material. Consequently, a dust core in a good condition can be obtained without applying a lubricant to a mold, even when the dust core has a hollow cylindrical shape with a large height and a small wall thickness, that is, the dust core has a shape in which seizing or exfoliation is likely to occur during the compression molding.

The hollow cylinder has an outer diameter D of not less than 30 mm. With the dust core formed in this manner, since it has a large outer diameter, it is difficult to apply a lubricant uniformly to a wide range of the inner wall of a mold at the time of compression molding. However, with an aid of the organic substance added to the soft magnetic material at a predetermined ratio, a dust core in a good condition having no exfoliation or seizing can be obtained without applying a lubricant to a mold when the outer diameter is not less than 30 mm.

A motor core according to one aspect of the present invention uses the dust core described above. With the motor core formed in this manner, a desired magnetic property can be achieved and a good appearance can be obtained.

A method of manufacturing a dust core according to one aspect of the present invention is a method of manufacturing the dust core described above. The method of manufacturing the dust core includes the steps of preparing a mold having an inner wall and defining a compression space at a location surrounded by the inner wall, and putting the soft magnetic material into the compression space without applying a lubricant to the inner wall, and compression molding the soft magnetic material. With the method of manufacturing the dust core arranged in this manner, the organic substance added to the soft magnetic material at a predetermined ratio serves as a lubricant during the compression molding. Consequently, compression molding can be performed without causing exfoliation or seizing even when a lubricant is not applied to the inner wall of the mold.

Preferably, the method of manufacturing the dust core further includes the step of performing thermal treatment after the step of compression molding, at a temperature of more than a glass transition temperature of the organic substance and not more than a thermal decomposition temperature of the organic substance. A glass transition temperature is a temperature at which an amorphous high-molecular material shifts from a glass-like solid to a rubber-like state with an increase in temperature. Although some organic substances do not have specific glass transition temperatures, a thermal treatment temperature for such a substance may be set based on a melting point of the substance instead of a glass transition temperature. With the method of manufacturing the dust core arranged in this manner, the organic substance can surely join the composite magnetic particles together to improve the strength of a molding.

A method of manufacturing a dust core according to another aspect of the present invention includes the steps of mixing a plurality of composite magnetic particles each having a metal magnetic particle and an insulating film surrounding a surface of the metal magnetic particle, and an organic substance having a deflection temperature under load of not more than 100° C. (under a load of 1.82 MPa) to form a mixture, and compression molding the mixture to form a molding.

With the method of manufacturing the dust core arranged in this manner, in the step of forming a molding, heat generated by the compression raises the temperature of the mixture to a temperature close to 100° C. On this occasion, the organic substance serves as a cushioning material between the plurality of composite magnetic materials since the organic substance has the deflection temperature under load of not more than 100° C. (under the load of 1.82 MPa). This function of the organic substance can prevent the composite magnetic particles from rubbing against each other to apply a local force to the insulating film surrounding the surface of the metal magnetic particle. Thereby, insulation between the metal magnetic particles by means of the insulating film can be maintained even after the compression molding, suppressing an occurrence of interparticle eddy current. Therefore, according to the present invention, a dust core in which a reduction in magnetic permeability is suppressed even when a high-frequency alternating-current magnetic field is applied can be implemented.

Further, a good dust core can be obtained by preheating powder or a mold, or both of them by means of warm mold forming, which is a known technique, in the step of compression molding a molding.

Preferably, the method of manufacturing the dust core further includes the step of performing thermal treatment on the molding at a temperature of more than a glass transition temperature of the organic substance and not more than a thermal decomposition temperature of the organic substance. With the method of manufacturing the dust core arranged in this manner, thermal decomposition of the organic substance can be suppressed, and the organic substance can be deformed to fit into a space between the plurality of composite magnetic particles to enter the space. Thereby, the organic substance can surely join the composite magnetic particles together to improve the strength of the molding.

A motor core according to another aspect of the present invention is fabricated using the method of manufacturing the dust core described above.

### EFFECTS OF THE INVENTION

As described above, according to the present invention, a soft magnetic material having a desired magnetic property, a dust core, a transformer core, a motor core, and a method of manufacturing a dust core can be provided.

### BRIEF DESCRIPTION OF THE DRAWINGS

FIG. 1 is an enlarged schematic view showing a dust core using a soft magnetic material in a first embodiment of the present invention.

FIG. 2 is a cross sectional view showing a linear motor in a second embodiment of the present invention.

FIG. 3 is a graph showing relationship between a decrease ratio μA/μB in magnetic permeability and each frequency in a first example.

FIG. 4 is a graph showing relationship between a frequency at which a magnetic permeability μA is 5% less than a magnetic permeability μB and a deflection temperature under load of an organic substance in the first example.

FIG. 5 is a perspective view showing a dust core fabricated in a second example.

FIG. 6 is a cross sectional view showing a mold used for the fabrication of the dust core in FIG. 5.

### DESCRIPTION OF THE REFERENCE SIGNS

1 inner core, 2 outer core, 10 metal magnetic particle, 20 insulating film, 30 composite magnetic particle, 40 organic substance, 60 dust core, 70 mold, 71 inner wall, 72 compression space, 74 core bar, 75 lower punch, 76 upper punch.

### BEST MODE FOR CARRYING OUT THE INVENTION

Embodiments of the present invention will be described with reference to the drawings.

### First Embodiment

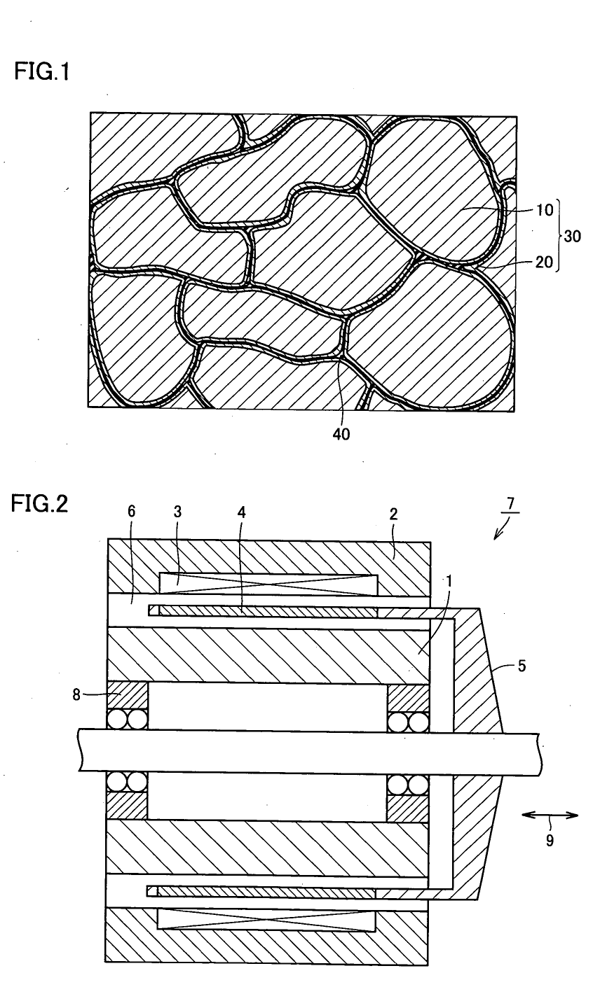

Referring to FIG. 1, a soft magnetic material includes a plurality of composite magnetic particles 30 each having a metal magnetic particle 10 and an insulating film 20 surrounding the surface of metal magnetic particle 10.

Between the plurality of composite magnetic particles 30 is disposed an organic substance 40 having a deflection temperature under load of not more than 100° C. (under a load of 1.82 MPa). Generally, a deflection temperature under load is higher than a glass transition temperature. The plurality of composite magnetic particles 30 are joined together by organic substance 40 or by a meshing engagement between concave and convex portions of composite magnetic particles 30.

Metal magnetic particle 10 can be made of, for example, iron (Fe), an iron (Fe)-silicon (Si) based alloy, an iron (Fe)-nitrogen (N) based alloy, an iron (Fe)-nickel (Ni) based alloy, an iron (Fe)-carbon (C) based alloy, an iron (Fe)-boron (B) based alloy, an iron (Fe)-cobalt (Co) based alloy, an iron (Fe)-phosphorus (P) based alloy, an iron (Fe)-nickel (Ni)-cobalt (Co) based alloy, and an iron (Fe)-aluminum (Al)-silicon (Si) based alloy. Metal magnetic particle 10 may be made of a single metal, or may be an alloy.

Metal magnetic particle 10 preferably has an average particle size of not less than 5 μm and not more than 300 μm. When metal magnetic particle 10 has the average particle size of not less than 5 μm, the metal is less oxidized, and thus the magnetic property of the soft magnetic material can be improved. When metal magnetic particle 10 has the average particle size of not more than 300 μm, there is no possibility that compressibility of mixed powder is reduced during the molding step which will be described later. Thereby, the density of a molding obtained through the molding step can be increased.

It is to be noted that the average particle size described herein refers to a particle size obtained when the sum of masses of particles added in ascending order of particle size in a histogram of particle sizes measured by sieving reaches 50% of the total mass, that is, 50% particle size D.

Insulating film 20 can be formed by treating metal magnetic particle 10 with phosphoric acid. Further, insulating film 20 preferably contains an oxide. As insulating film 20 containing an oxide, an oxide insulator can be used, such as iron phosphate containing phosphorus and iron, manganese phosphate, zinc phosphate, calcium phosphate, silicon oxide, titanium oxide, aluminum oxide, or zirconia oxide.

Insulating film 20 serves as an insulating layer between metal magnetic particles 10. By covering metal magnetic particle 10 with insulating film 20, electric resistivity ρ of the dust core can be increased. This can suppress eddy current from flowing between metal magnetic particles, and reduce core loss of the dust core resulting from the eddy current.

Insulating film 20 preferably has a thickness of not less than 0.005 μm and not more than 20 μm. By setting the thickness of insulating film 20 at not less than 0.005 μm, energy loss due to eddy current can effectively be suppressed. Further, by setting the thickness of insulating film 20 at not more than 20 μm, there is no possibility that the ratio of insulating film 20 to the soft magnetic material will be too high. This can prevent a significant reduction in a magnetic flux density of the dust core.

Organic substance 40 can be formed for example of polytetrafluoroethylene (Teflon®) having a deflection temperature under load of 50° C., 6-12 nylon having a deflection temperature under load of 60° C., 6 nylon having a deflection temperature under load of 65° C., 6-6 nylon having a deflection temperature under load of 70° C., polybutylene terephthalate (PBT) having a deflection temperature under load of 78° C., and polyphenylene ether (PPE) having a deflection temperature under load of 85° C. It is to be noted that these deflection temperatures under load mentioned above are representative values under the load of 1.82 MPa, and it is conceivable that a slight difference may occur due to an error in measurement.

The ratio of organic substance 40 to the soft magnetic material is preferably more than 0 and not more than 1.0% by mass. In this case, a magnetic flux density B100 when a magnetic field of 100 (oersted) is applied is not less than 1.3 (tesla). By setting the ratio of organic substance 40 at not more than 1.0% by mass, the ratio of metal magnetic particle 10 in the soft magnetic material can be held at not less than a constant level. Thereby, a dust core having a higher magnetic flux density can be obtained.

More preferably, the ratio of organic substance 40 to the soft magnetic material is more than 0 and not more than 0.5% by mass. In this case, magnetic flux density B100 when a magnetic field of 100 (oersted) is applied is not less than 1.4 (tesla).

Further preferably, the ratio of organic substance 40 to the soft magnetic material is not less than 0.3% by mass and not more than 0.5% by mass. In this case, in addition to providing the above effects, organic substance 40 can sufficiently serve as a lubricant during compression molding which will be described later.

Next, explanation will be given on a method of manufacturing the dust core in FIG. 1. Firstly, composite magnetic particle 30 is fabricated by forming insulating film 20 on the surface of metal magnetic particle 10.

Thereafter, composite magnetic particle 30 and organic substance 40 are mixed to obtain mixed powder. There is no specific limitation on the mixing technique, and any mixing technique such as mechanical alloying, vibratory ball milling, planetary ball milling, mechanofusion, coprecipitation, chemical vapor deposition (CVD), physical vapor deposition (PVD), plating, sputtering, vapor deposition, or sol-gel process may be used.

Next, the obtained mixed powder is put into a mold to be compression molded under a pressure between 700 MPa and 1500 MPa. Thereby, the mixed powder is compressed to obtain a molding.

During the compression molding, the temperature of the mixed powder rises to about 100° C. On the other hand, under this temperature condition, organic substance 40 having a deflection temperature under load of not more than 100° C. (under a load of 1.82 MPa) is ready to deflect to some extent if it receives stress. Thus, organic substance 40 serves as a cushioning material between composite magnetic materials 30, preventing insulating film 20 from being destroyed by the contact between composite magnetic particles 30.

Further, when the ratio of organic substance 40 to the soft magnetic material is set at not less than 0.3% by mass, a molding having no exfoliation therefrom and having no seizing to a mold can be fabricated without using a mold lubricant. By setting the ratio of organic substance 40 to the soft magnetic material preferably at not less than 0.3% by mass and not more than 0.5% by mass, a dust core having a magnetic property that magnetic flux density B100 when a magnetic field of 100 (oersted) is applied is not less than 1.4 (tesla) can be obtained without using a mold lubricant.

Next, the molding obtained by compression molding is subjected to thermal treatment at a temperature of more than a glass transition temperature of organic substance 40 and not more than a thermal decomposition temperature of organic substance 40. This allows organic substance 40 to enter between composite magnetic particles 30, while suppressing organic substance 40 from being subjected to thermal decomposition. Further, distortion and dislocation caused inside the molding during the compression molding can be removed. Through the steps described above, the dust core in FIG. 1 is completed.

With the soft magnetic material, the dust core, and the method of manufacturing the dust core formed in this manner, compression molding can be performed without damaging insulating film 20 with the aid of organic substance 40 having a predetermined deflection temperature under load, and thus insulating film 20 can fully serve as an insulating layer between metal magnetic particles 10. This can reliably suppress the occurrence of an interparticle eddy current loss, and suppress a reduction in magnetic permeability even when a high-frequency alternating-current magnetic field is applied to the dust core. Note that the soft magnetic material having such a property can be used for a dust core, a choke coil, a switching power supply element, a magnetic head, various types of motor components, a solenoid for automobile, various types of magnetic sensors and electromagnetic valves, and the like.

### Second Embodiment

Referring to FIG. 2, in a linear motor 7, an iron core for a motor is fabricated using the soft magnetic material described in the first embodiment.

Linear motor 7 includes an inner core 1, an outer core 2 with a gap 6 perpendicular to an axis direction (a direction indicated by an arrow 9) formed between inner core 1 and outer core 2, a coil 3 provided within outer core 2, and a magnet 4 positioned within gap 6, and has a movable body 5 integrated with magnet 4 and movable in the axis direction. Movable body 5 is supported by a bearing 8.

One or both of inner core 1 and outer core 2 which are conventionally formed of a layered body of sheet iron are replaced with the soft magnetic material described in the first embodiment. This can significantly simplify the assembling process of linear motor 7.

In this structure, while linear motor 7 is in operation, a magnetic flux passes through the inside of inner core 1 and outer core 2, and eddy current is generated around a magnetic field line on this occasion. When the core has a low electric resistance in a direction in which the magnetic field line passes through, the eddy current is increased, and the increased amount is consumed as invalid energy in motor input. This results in a reduction in motor efficiency. Consequently, it is desirable for inner core 1 and outer core 2 to easily allow passage of the magnetic flux and to have a high electric resistance. These desirable properties can be satisfied with inner core 1 and outer core 2 formed of the soft magnetic material in accordance with the present invention, implementing linear motor 7 which is highly efficient and easily assembled.

It is to be noted that, although explanation has been given on a linear motor, the soft magnetic material in accordance with the present invention can also be-applied to an iron core for a typical rotating motor. Also in this case, a core which has only a small energy loss due to eddy current and is easy to manufacture can be implemented.

### EXAMPLES

The soft magnetic material in accordance with the present invention was evaluated in examples which will be described below.

### First Example

The dust core in FIG. 1 was fabricated according to the manufacturing method described in the first embodiment. On this occasion, “Somaloy 500” manufactured by Hoeganaes Corporation was used as composite magnetic particle 30. In this particle, a phosphate compound film as the insulating film is formed on the surface of an iron particle as the metal magnetic particle. The average particle size of the iron particle is not more than 150 μm, and the average thickness of the phosphate compound film is 20 nm.

Materials used as organic substance 40 included “Lubron L5” manufactured by Daikin Industries, Ltd. as Teflon®, “Zytel 151L” manufactured by DuPont as 6-12 nylon, “A1030BRL” manufactured by Unitika Ltd. as 6 nylon, “1300S” manufactured by Asahi Kasei Corporation as 6-6 nylon, “Duranex 2002” manufactured by Polyplastics Co., Ltd. as PBT, and “Xylon 100V” manufactured by Asahi Kasei Corporation as PPE.

Further, to confirm the effect of the present invention, a dust core was fabricated using organic substance 40 having a deflection temperature under load of more than 100° C. (under the load of 1.82 MPa). On this occasion, materials used as organic substance 40 included “Duracon M90S” manufactured by Polyplastics Co., Ltd. as POM (a polyacetal resin), “Techtron PPS” manufactured by Nippon Polypenco Ltd. as PPS (polyphenylene sulfide), “Ultem” manufactured by General Electric Company, and “UIP-R” manufactured by Ube Industries, Ltd. Chemically, “UIP-R” is a wholly aromatic polyimide using biphenyl tetracarboxylic dianhydride.

The ratio of organic substance 40 was changed from 0.01% by mass to 1% by mass. The pressure during compression molding was set at 900 MPa, and thermal treatment was performed at a temperature from 250° C. to 300° C. for one hour.

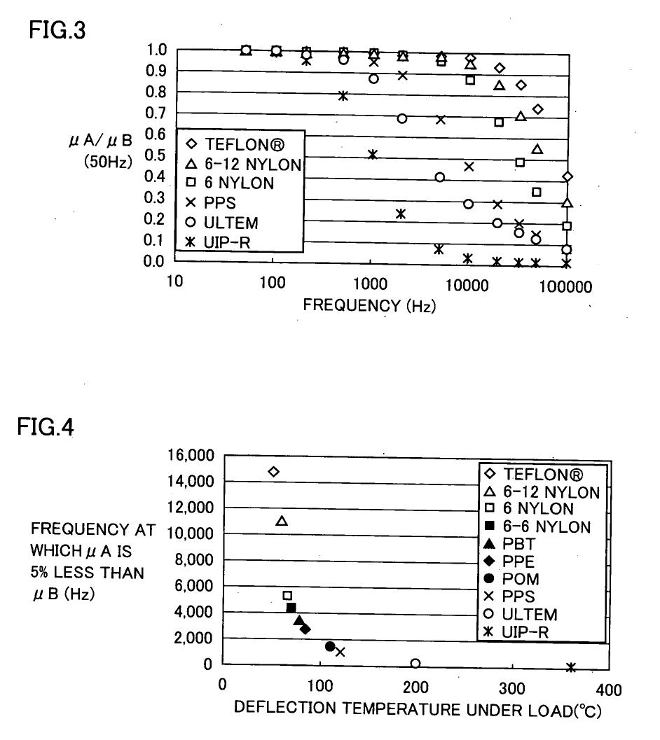

Next, an alternating-current magnetic field was applied to the dust core of the obtained molding at room temperature, with a frequency changed in a range from 50 Hz to 100000 Hz, to measure magnetic permeability μA for each frequency. Then, the magnetic permeability obtained when applying a 50 Hz alternating-current magnetic field was set as μB, and μA/μB was determined to check how much the magnetic permeability decreased with an increase in the frequency. FIG. 3 is a graph showing relationship between a decrease ratio μA/μB in the magnetic permeability and each frequency in the first example. FIG. 3 shows the results obtained when the ratio of organic substance 40 was 0.1% by mass.

Further, a frequency at which magnetic permeability μA obtained by the measurement was 5% less than magnetic permeability μB obtained when applying the 50 Hz alternating-current magnetic field was determined, and shown in Table 1 and FIG. 4 for each organic substance 40 and its ratio. Of the results shown in Table 1, FIG. 4 particularly shows the results obtained when the ratio of organic substance 40 was 0.1% by mass.

TABLE 1

| | | Deflection | Frequency at which μA is 5% less than μB (Hz) | | | | | |
|---|---|---|---|---|---|---|---|---|
| | | Temperature | 0.01 | 0.05 | 0.1 | 0.3 | 0.4 | 0.5 |
| | Organic | under Load | (% by | (% by | (% by | (% by | (% by | (% by |
| | Substance | (° C.) | mass) | mass) | mass) | mass) | mass) | mass) |
| Example product | Teflon ® | 50 | 10,141 | 11,660 | 14,758 | 34,611 | 44,613 | 55,038 |
| | 6-12 nylon | 60 | 3,020 | 5,750 | 10,823 | 15,754 | 18,012 | 20,785 |
| | 6 nylon | 65 | 1,953 | 2,888 | 5,142 | 10,788 | 13,583 | 16,734 |
| | 6-6 nylon | 70 | 1,631 | 2,412 | 4,295 | 10,121 | 13,034 | 15,817 |
| | PBT | 78 | 1,240 | 1,834 | 3,266 | 7,419 | 9,502 | 11,603 |
| | PPE | 85 | 1,010 | 1,494 | 2,659 | 5,876 | 7,439 | 9,058 |
| Comparative product | POM | 110 | 552 | 883 | 1,369 | 2,766 | 3,433 | 4,159 |
| | PPS | 121 | 379 | 607 | 940 | 2,306 | 3,015 | 3,638 |
| | Ultem | 200 | 81 | 170 | 201 | 375 | 459 | 532 |
| | (product name) | | | | | | | |
| | UIP-R | 360 | 59 | 120 | 147 | 330 | 419 | 498 |
| | (Product Name) | | | | | | | |

Referring to FIG. 3, in the example products of the present invention, it has been found that magnetic permeability μA decreases little until the frequency exceeds around 10000 Hz. Referring to Table 1 and FIG. 4, it has been found that the frequency at which magnetic permeability μA is 5% less than magnetic permeability μB is greater as the deflection temperature under load is lower, and that there is substantially no problem in particular even when the frequency exceeds 10000 Hz in the example product using 6-12 nylon as organic substance 40, and the frequency exceeds 15000 Hz in the example product using Teflon® as organic substance 40.

Next, a magnetic field of 100 (oersted) was applied to the dust core of the molding to measure magnetic flux density B100 at that occasion. Table 2 shows the measured results for each organic substance 40 and its ratio.

TABLE 2

| | | Deflection | Magnetic Flux Density B100 (tesla) | | | | | | |
|---|---|---|---|---|---|---|---|---|---|
| | | Temperature | 0.01 | 0.1 | 0.3 | 0.4 | 0.5 | 0.7 | 1.0 |
| | Organic | under Load | (% by | (% by | (% by | (% by | (% by | (% by | (% by |
| | Substance | (° C.) | mass) | mass) | mass) | mass) | mass) | mass) | mass) |
| Example product | Teflon ® | 50 | 1.55 | 1.54 | 1.51 | 1.50 | 1.49 | 1.46 | 1.43 |
| | 6-12 nylon | 60 | 1.54 | 1.53 | 1.51 | 1.49 | 1.47 | 1.44 | 1.40 |
| | 6 nylon | 65 | 1.55 | 1.53 | 1.50 | 1.49 | 1.48 | 1.43 | 1.40 |
| | 6-6 nylon | 70 | 1.53 | 1.52 | 1.49 | 1.47 | 1.44 | 1.42 | 1.36 |
| | PBT | 78 | 1.52 | 1.51 | 1.46 | 1.45 | 1.43 | 1.38 | 1.33 |
| | PPE | 85 | 1.52 | 1.51 | 1.47 | 1.45 | 1.42 | 1.39 | 1.32 |
| Com. Product | POM | 110 | 1.53 | 1.50 | 1.43 | 1.40 | 1.38 | 1.34 | 1.24 |
| | PPS | 121 | 1.53 | 1.52 | 1.44 | 1.40 | 1.38 | 1.32 | 1.23 |

Referring to Table 2, it has been confirmed that, in the example products of the present invention, a magnetic flux density of not less than 1.3 (tesla) can be obtained when the ratio of organic substance 40 is not more than 1% by mass, and a magnetic flux density of not less than 1.4 (tesla) can further be obtained when the ratio of organic substance 40 is not more than 0.5% by mass.

It has been confirmed from the above results that, according to the present invention, it is possible to fabricate a dust core in which high magnetic flux density can be obtained by minimizing the ratio of organic substance 40, and higher magnetic permeability can be maintained up to a high frequency even when the ratio of organic material 40 is low.

### Second Example

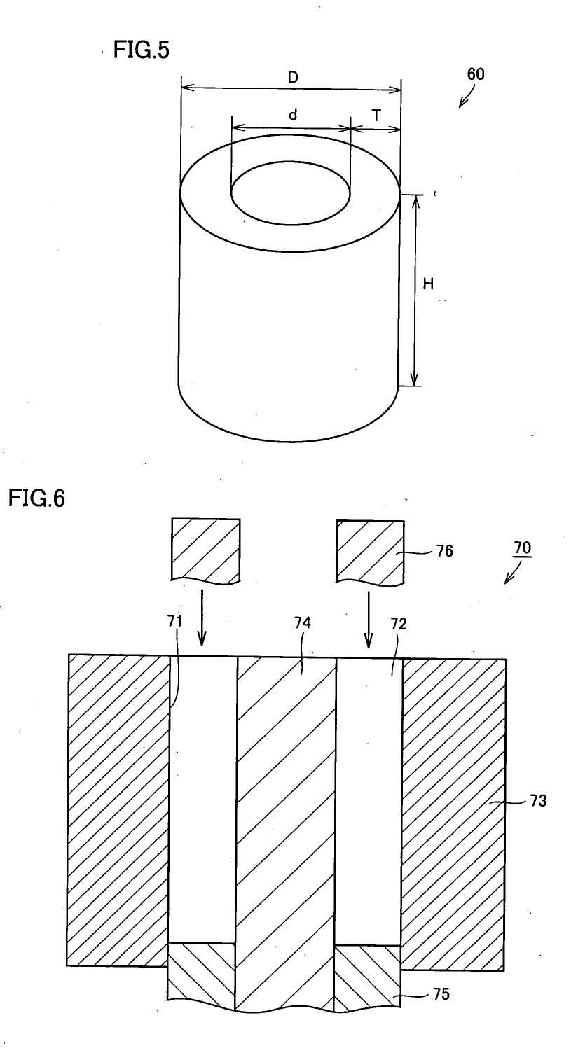

Referring to FIGS. 5 and 6, in the present example, a mixture of “Somaloy 500” used in the first example and each organic substance 40 was compression molded under a pressure of 980 MPa, using a mold 70. Mold 70 includes a die 73 having an inner wall 71 and defining a compression space 72 at a location surrounded by inner wall 71, a core bar 74 disposed within compression space 72, and an upper punch 76 and a lower punch 75 disposed at an upper portion and a lower portion, respectively, of compression space 72. At the time of the compression molding, a lubricant was not applied to inner wall 71 of mold 70.

Through the compression molding, a dust core 60 having a simple hollow cylindrical shape with an inner diameter d of 50 mm, an outer diameter D of 60 mm, a wall thickness T of 5 mm, and a height H of 30 mm, was fabricated as shown in FIG. 5. The amount of organic substance 40 added was changed, and the surface of dust core 60 obtained for each amount was observed. Table 3 shows the results for each organic substance 40 and its ratio, with a surface having exfoliation or a mark left as a result of seizing to the mold indicated as “x”, and with a surface having no such appearance indicated as “o”.

TABLE 3

| | | Deflection | Ratio of Organic Substance | | | | | | |
|---|---|---|---|---|---|---|---|---|---|
| | | Temperature | 0.01 | 0.1 | 0.3 | 0.4 | 0.5 | 0.7 | 1.0 |
| | Organic | under Load | (% by | (% by | (% by | (% by | (% by | (% by | (% by |
| | Substance | (° C.) | mass) | mass) | mass) | mass) | mass) | mass) | mass) |
| Example product | Teflon ® | 50 | X | X | ◯ | ◯ | ◯ | ◯ | ◯ |
| | 6-12 nylon | 60 | X | X | ◯ | ◯ | ◯ | ◯ | ◯ |
| | 6 nylon | 65 | X | X | ◯ | ◯ | ◯ | ◯ | ◯ |
| | 6-6 nylon | 70 | X | X | ◯ | ◯ | ◯ | ◯ | ◯ |
| | PBT | 78 | X | X | ◯ | ◯ | ◯ | ◯ | ◯ |
| | PPE | 85 | X | X | ◯ | ◯ | ◯ | ◯ | ◯ |
| Com. product | POM | 110 | X | X | X | X | X | X | X |
| | PPS | 121 | X | X | X | X | X | X | X |

As can be seen in Table 3, dust core 60 having no exfoliation or a seizing mark on the surface was able to be fabricated by setting the ratio of the organic substance at not less than 0.3% by mass.

Since manual application of a lubricant onto a mold has a problem of productivity, a lubricant is generally applied to the inner wall of a mold by mechanical means such as spraying. To lubricate a mold effectively, it is necessary to apply a lubricant uniformly all over the inner wall of the mold by ejecting the lubricant just once. However, for a molding with some shape, a core bar (core) is disposed within a mold, and some portion is hidden behind the core bar during the ejection of a lubricant and thus not subjected to the application of the lubricant. In addition, when the molding has a long body with a thin wall, a lubricant is hard to enter deeply into a narrow space, and it becomes difficult to apply the lubricant uniformly all over the inner wall. Further, there arise problems that a lubricant cannot be applied uniformly due to the cylindrical shape of the molding, and that, when the molding has a large outer diameter, the distance from an ejection nozzle to the inner wall of the mold becomes too long to allow a lubricant to be applied to the inner wall of the mold.

Consequently, the ratio of the organic substance to the soft magnetic material is set at not less than 0.3% by mass to allow the fabrication of a molding having a complicated structure without using a mold lubricant. By setting the ratio of the organic substance to the soft magnetic material preferably at not less than 0.3% by mass and not more than 0.5% by mass, a dust core having a magnetic property that magnetic flux density B100 when a magnetic field of 100 (oersted) is applied is not less than 1.4 (tesla) can be obtained without using a mold lubricant.

It should be considered that the embodiments and the examples disclosed herein are by way of illustration in all respects and not to be taken by way of limitation. The scope of the present invention is set forth by the claims rather than the above description, and is intended to cover all the modifications within a spirit and scope equivalent to those of the claims.

### INDUSTRIAL APPLICABILITY

The present invention is mainly applied to electric and electronic components such as a motor core, a transformer core, or the like formed of a powder-compressed molding of a soft magnetic material.

1. A soft magnetic material, comprising:
a plurality of composite magnetic particles each having a metal magnetic particle and an insulating film surrounding a surface of said metal magnetic particle, and
an organic substance joining said plurality of composite magnetic particles together,
wherein said organic substance has a deflection temperature under load of not more than 70° C., and a magnetic flux density when a magnetic field of 100 (oersted) is applied to a dust core fabricated using the soft magnetic material is not less than 1.4 (T: tesla).

2. The soft magnetic material according to claim 1, wherein a ratio of said organic substance to the soft magnetic material is not less than 0.3% by mass and not more than 0.5% by mass.

3. A dust core using the soft magnetic material according to claim 2, wherein the dust core is formed as a hollow cylinder having a height H and a wall thickness T, said height H being not less than 25 mm and a ratio H/T of said height H to said wall thickness T being not less than 3.

4. The dust core according to claim 3, wherein said hollow cylinder has an outer diameter of not less than 30 mm.

5. A linear motor core using the dust core according to claim 3.

6. A transformer core using the dust core according to claim 3.

7. A method of manufacturing the dust core according to claim 3, comprising the steps of:
preparing a mold having an inner wall and defining a compression space at a location surrounded by said inner wall, and
putting the soft magnetic material into said compression space without applying a lubricant to said inner wall, and compression molding the soft magnetic material.

8. The method of manufacturing the dust core according to claim 7, further comprising the step of performing thermal treatment after said step of compression molding, at a temperature of more than a glass transition temperature of said organic substance and not more than a thermal decomposition temperature of said organic substance.

9-15. (canceled)
